(19) United States
(12) Patent Application Publication
(10) Pub. No.: US 2006/0137413 A1
(43) Pub. Date: Jun. 29, 2006

(54) Unlocking device that can be connected to suitcase for security inspection and method for using the same

(76) Inventor: Chun Te Yu, Township (TW)

Correspondence Address: ROSENBERG, KLEIN & LEE, 3458 ELLICOTT CENTER DRIVE-SUITE 101, ELLICOTT CITY, MD, 21043, US

(21) Appl. No.: 11/356,083

(22) Filed: Feb. 17, 2006

Related U.S. Application Data
(63) Continuation-in-part of application No. 10/942,790, filed on Sep. 17, 2004.
(63) Continuation-in-part of application No. 10/942,841, filed on Sep. 17, 2004.

(30) Foreign Application Priority Data
Feb. 17, 2005 (TW) 094202638
Aug. 17, 2005 (TW) 094128099

(51) Int. Cl. E05B 65/52

(52) U.S. Cl. 70/63

(57) ABSTRACT

An unlocking device that can be connected to a suitcase for security inspections comprises a shell, a seal member, a combination lock module, a key lock module and an unlocking unit. The seal member is connected to the shell and movable between an unlocking position and a locking position relative to the shell. The combination lock module is installed in the shell and provided for allowing the seal member to move from the locking position to the unlocking position after the combination lock module is unlocked. Additionally, the key lock module is installed in the shell and provided for allowing the seal member to move from the locking position to the unlocking position after the key lock module is unlocked. The unlocking unit is connected to the seal member and provided for unlocking the suitcase after the seal member is moved to the unlocking position.

### CROSS REFERENCE TO RELATED APPLICATION

This application is a continuation-in-part application of co-pending U.S. application Ser. No. 10/942,790 filed Sep. 17, 2004, and also is a continuation-in-part application of co-pending U.S. application Ser. No. 10/942,841 filed Sep. 17, 2004.

### FIELD OF THE INVENTION

This invention relates generally to an unlocking device that can be connected to a suitcase, a baggage or a case. A security inspector can use an exclusive key to open the unlocking device so as to obtain an unlocking unit pre-placed in the unlocking device for opening the suitcase.

### BACKGROUND OF THE INVENTION

To prevent customs or security inspector from directly breaking a locked suitcase for carrying out an inspection of it, some solutions regarding to this are provided in U.S. Patent Pub. Nos. 2004/0226323, 2004/0226324, 2005/0044901, 2005/0039500, and 2005/0039501 that relate to padlocks for the suitcases. Such a padlock generally provides a combination lock module for the owner of the suitcase to use, and a key lock module for a suitcase inspector to use. Additionally, the key lock module can be opened by an exclusive key kept by the inspector. Therefore, the padlock can be opened by either the key lock module or the combination lock module. Accordingly, as long as the suitcase is locked by such a padlock, the suitcase inspector can first use the exclusive key to open the padlock and to carry out inspection of the suitcase.

However, the conventional padlocks disclosed above are not suitable for locking the suitcases because the suitcases are designed to be locked by means of a key lock module and a combination lock module that are already fixed onto the suitcases themselves. Consequently, the suitcase inspector still needs to break such suitcases.

Furthermore, the locks disclosed in U.S. Pat. Nos. 4,896,517, 4,543,806 and 5,156,028 mainly relate to a structure with a cable, which is retractable to a spool. Currently, such applications for the structure with the cable and spool have yet to be seen in the lock industry.

### SUMMARY OF INVENTION

The primary objective of the present invention is to provide an unlocking device that can be connected to a suitcase in different manners, such as hanging the unlocking device on the suitcase, integrating the unlocking device with the suitcase itself, or making the unlocking device slidable to the suitcase. Thus, the unlocking device always connects to the suitcase. More importantly, the unlocking device comprises an unlocking unit, which can be obtained by using either one of a combination lock module and a key lock module, so as to open the suitcase.

More particularly, the unlocking device comprises a shell, a seal member, a combination lock module, a key lock module, and an unlocking unit. The shell can be connected to the suitcase in any suitable manners. The seal member is connected to the shell and movable between an unlocking position and a locking position relative to the shell. Additionally, the combination lock module is installed in the shell for allowing the seal member to move from the locking position to the unlocking position after the combination lock module is unlocked. The key lock module can be installed in either one of the shell and the seal member, and provided for allowing the seal member to move from the locking position to the unlocking position after the key lock module is unlocked.

Furthermore, the unlocking unit can be received in either one of the shell and the seal member and provided for unlocking the suitcase after the seal member is moved to the unlocking position. The unlocking unit comprises an unlocking key provided for unlocking a key lock of the suitcase; and an indicator provided for unlocking the combination lock of the suitcase. An exclusive key kept by a suitcase inspector is used to unlock the key lock module; therefore, the seal member can be moved to the unlocking position after the key lock module is unlocked by the suitcase inspector. Accordingly, the unlocking unit can be obtained so the suitcase inspector can use the unlocking unit, namely the unlocking key or the indicator to unlock and to inspect the suitcase.

In one embodiment of the present invention, a body of the seal member is connected with an end of a cable whose the other end is wound around a spool, which is installed in the shell and is capable of retracting the cable automatically. Additionally, the unlocking unit connected to the seal member is safely kept.

Therefore, the unlocking device connected to the suitcase and the unlocking unit obtained through the exclusive key can assist the suitcase inspector to check the suitcase successfully without necessary for breaking the suitcase. Furthermore, the unlocking device can be hanged on and attached to the suitcase without any additional changes to the suitcase designs; therefore, the unlocking device also is suitable to ready-made suitcases. Additionally, the unlocking device can be also served as a tag for a further application.

### BRIEF DESCRIPTION OF DRAWINGS

The invention will be more clearly understood after referring to the following detailed description read in conjunction with the drawings wherein:

FIG. 1 is a perspective view of a first embodiment of the present invention;

FIG. 2 is an exploded view of the first embodiment of the present invention;

FIG. 3 is an exploded view of the first embodiment of the present invention, showing a different angle of the first embodiment;

FIG. 4 is a perspective view of the first embodiment, showing a structure of a key lock module, a button, a linking unit and a plate;

FIG. 5 is a cross-sectional view of the first embodiment, showing a key lock module and a combination lock module being locked;

FIG. 6 is a cross-sectional view of the first embodiment, showing the combination lock module being unlocked and a seal member being movable;

FIG. 7 is an operational view of the first embodiment, showing the seal member being moved to an unlocking position;

FIG. 8 is a cross-sectional view of the first embodiment, showing the key lock module being unlocked;

FIG. 9 is a cross-sectional bottom view of the first embodiment, as shown in FIG. 8;

FIG. 10 is a perspective view of a second embodiment of the present invention;

FIG. 11 is an exploded view of a third embodiment of the present invention;

FIG. 12 is an operational view of the third embodiment, showing a seal member being movable to an unlocking position;

FIG. 13, is a cross-sectional view of the third embodiment, showing a fastening member being operated;

FIG. 14 is a cross-sectional view of the third embodiment, showing the seal member being movable due to a combination lock module being unlocked;

FIG. 15 is a cross-sectional view of the third embodiment, showing the seal member being connected to a shell and locked by a key lock module;

FIG. 16 a cross-sectional view of the third embodiment, showing the seal member being movable due to the key lock module being unlocked

FIG. 17 is a cross-sectional view of the third embodiment, showing indicating members being adjusted;

FIG. 18 is a partially cross-sectional view of the third embodiment, showing the indicating members being locked;

FIG. 19 is a partially cross-sectional view of the third embodiment, showing the indicating members being unlocked;

FIG. 20 is a perspective view of a fourth embodiment of the present invention;

FIG. 21 is a perspective view of a fifth embodiment of the present invention;

FIG. 22 is a perspective view of a sixth embodiment of the present invention;

FIG. 23 is a perspective view of a seventh embodiment of the present invention;

FIG. 24 is an enlarged view of the seventh embodiment, showing an unlocking device; and

FIG. 25 is a schematic flow diagram, showing a method for unlocking a suitcase.

### DETAILED DESCRIPTION OF THE EMBODIMENTS

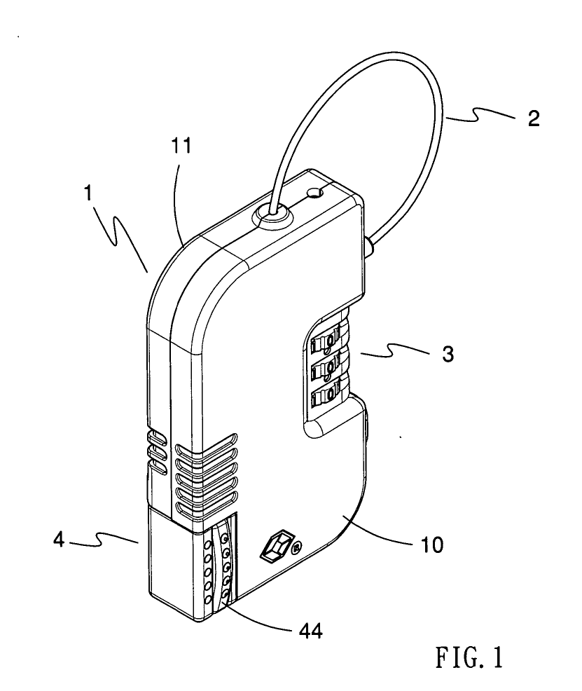

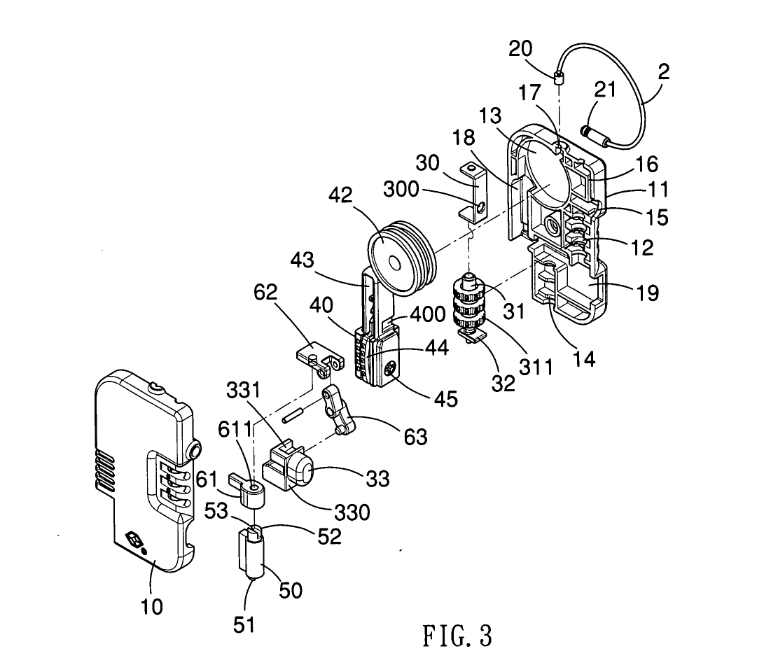

FIGS. 1-9 show an unlocking device that can be connected to a suitcase, as a first embodiment of the present invention. The unlocking device mainly comprises a shell 1, a fastening member 2, a combination lock module 3, a seal member 4, a key lock module 5, and an unlocking unit, which comprises a key 44 and an indicator 46. As shown in FIGS. 1-3, the shell 1 is formed by a front shell 10 and a back shell 11 that mutually covers one and another. The front shell 10 and the back shell 11 have a first chamber 12 formed at a side portion therein respectively, a second chamber 13 formed at an upper portion therein respectively, and a third chamber 14 formed at a lower portion therein respectively. A locking hole 15 is formed transversely on the shell 1 so as to communicate with the first chamber 12 and outside of the shell 1, and a sliding space 16 is formed and connected with the locking hole 15. Additionally, a connecting hole 17 is formed on the shell 1 and communicated with the second chamber 13 and outside of the shell 1. At a lower part of the second chamber 13 and the external side of the third chamber 14, a groove 18, preferably an inverted T-shape groove in the first embodiment, is formed and communicated with the second chamber 13. In addition, a sliding chamber 19 is formed between the first chamber 12 and the third chamber 14.

Furthermore, the fastening member 2 in the present invention is preferably a flexible material, such as a steel cable or another similar material. The fastening member 2 has a connecting end 20 connected to the connecting hole 17 of the shell 1; and a fastening end 21 is connected to the combination lock module 3 via the locking hole 15 and capable of entering in and exiting from the locking hole 15 of the shell 1. The fastening member 2 also forms a loop corresponding to the shell 1.

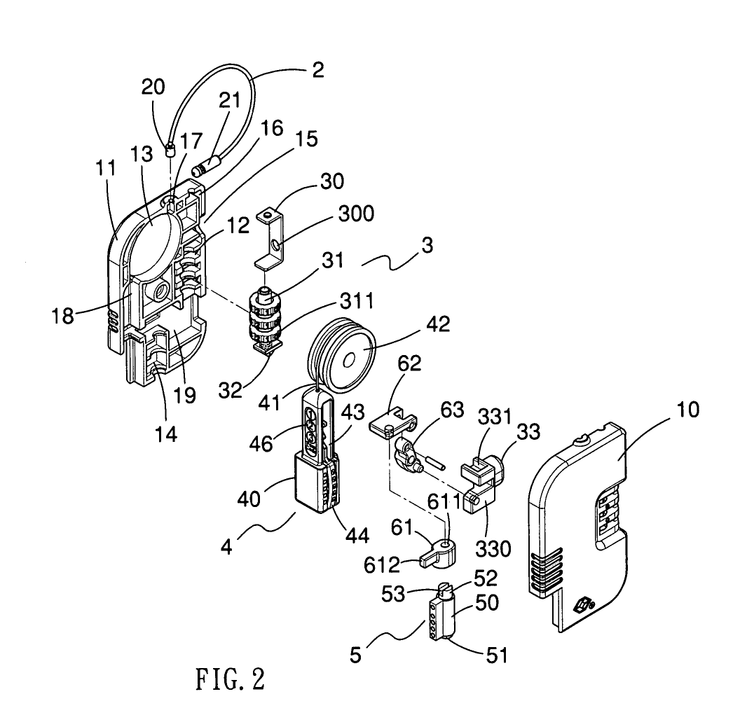

The combination lock module 3 as shown in FIGS. 2-3 and 5-6, is installed in the first chamber 12 of the shell 1, and mainly comprises a fastener 30, a stem 31, plural numeral wheels 311, a block 32, a button 33, a linking unit 63, and a plate 62. The fastener 30 is formed corresponding to the shape of the sliding space 16, and is able to slide along and to shift within the sliding space 16, so as to enable a fastening hole 300 of the fastener 30 to fasten or to release the fastening end 21 of the fastening member 2. Additionally, the stem 31 is movably installed in the shell 1. The numeral wheels 311 are installed on the stem 31 and provided for driving the stem 31 to move after unlocking numbers of the numeral wheels 311 are dialed. The numeral wheels 311 partially pass through the shell 1 so that the numeral wheels 311 can be turned and matched the numbers though outside of the shell 1.

Furthermore, a top of the stem 31 is capable of entering into the sliding space 16 and connecting to the fastener 30. The block 32 is elastically mounted on a bottom of the stem 31, and capable of protruding into the sliding chamber 19. In addition, the button 33 is movable connected to the block 32, and has a base 330 thereunder and a recess 331 theretop. The recess 331 of the button 33 is provided for receiving the block 32, and the base 330 of the button 33 is capable of sliding in the sliding chamber 19. A spring 332 is installed in the button 33 and provided for restoring the button 33 when the button 33 is pushed. When unlocking numbers of the numeral wheels 311 are dialed and the stem 31 is movable, the block 32 is movable upwardly to drive the fastener 30 to move, so as to release the fastening end 21 of the fastening member 2. Therefore, the fastening end 21 of the fastening member 2 can be pulled out from the locking hole 15 of the shell 1, and enable the fastening member 2 moving away from a hanging position on the suitcase to further be re-arranged to an appropriate position on the suitcase. Furthermore, the linking unit 63 is swingably connect to the button 33, and the plate 62 has a rod 620 and an end 621 connected to the linking unit 63.

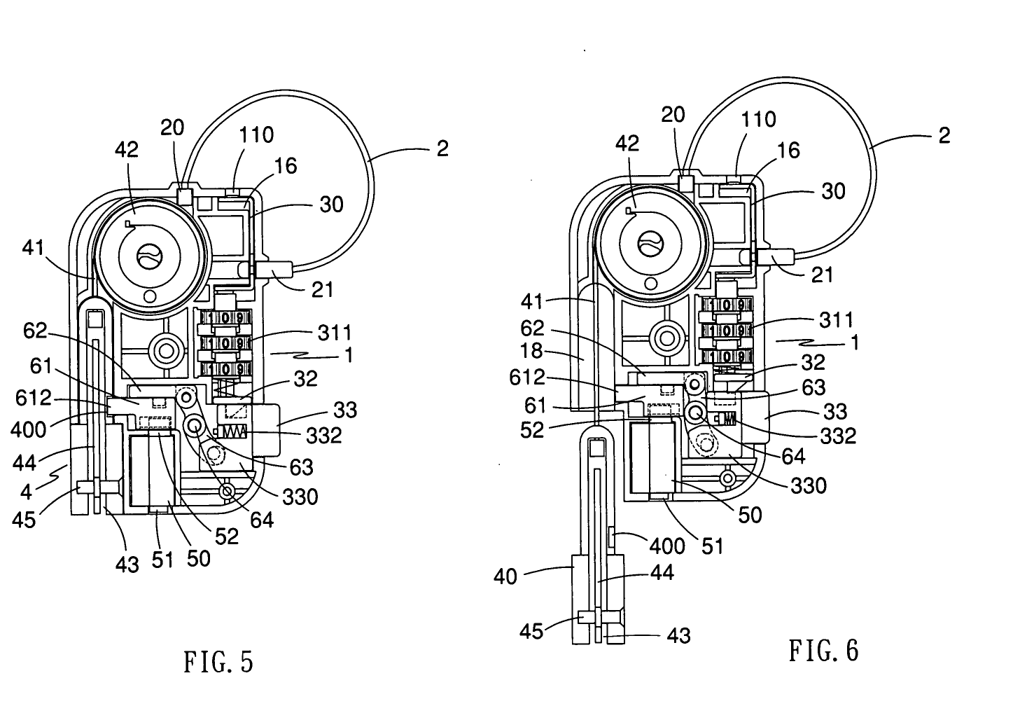

In FIGS. 2 and 5, the seal member 4 is connected to and installed in the groove 18 of the shell 1. The seal member 4 comprises a body 40, a cable 41 and a spool 42. The body 40 has a notch 400 formed thereon and facing the upper portion of the third chamber 14 of the shell 1. Preferably, the body 40 is in a T-shape so as to match the groove 18 of the shell 1. The spool 42 is installed in the second chamber 13 of the shell 1, and the cable 41 has one end for winding around the spool 42, and the other end for connecting to the body 40. The cable 41 is arranged to be retractable back to the spool 42 automatically, similar to the conventional cable and spool technology. Therefore, the seal member 4 is removable from the groove 18 in a limit range.

In the present invention, the unlocking unit comprises a key 44 and/or an indicator 46 that are installed in or connected to the seal member 4. The unlocking unit is provided for directly or indirectly unlocking the suitcase after the seal member 4 is moved to the unlocking position. As shown in FIGS. 2-3, 5 and 6, the body 40 of the seal member 4 is formed with a slot 43 provided for receiving the key 44, which is provided for unlocking a key lock of the suitcase. Additionally, a head of the key 44 is pivoted on a lower end of the body 40 by a spindle 45 within the slot 43; therefore, a body of the key 44 is rotatable to shift in and out from the seal member 44. Additionally, the body of the key 44 is restricted in the shell 1 when the key 44 is shifted in the seal member 4, which is accordingly installed in the groove 18. The body of the key 44 can be shifted out from the seal member 44 to unlock the key lock of the suitcase only after the seal member 4 is pulled out from the groove 18 at the unlocking position.

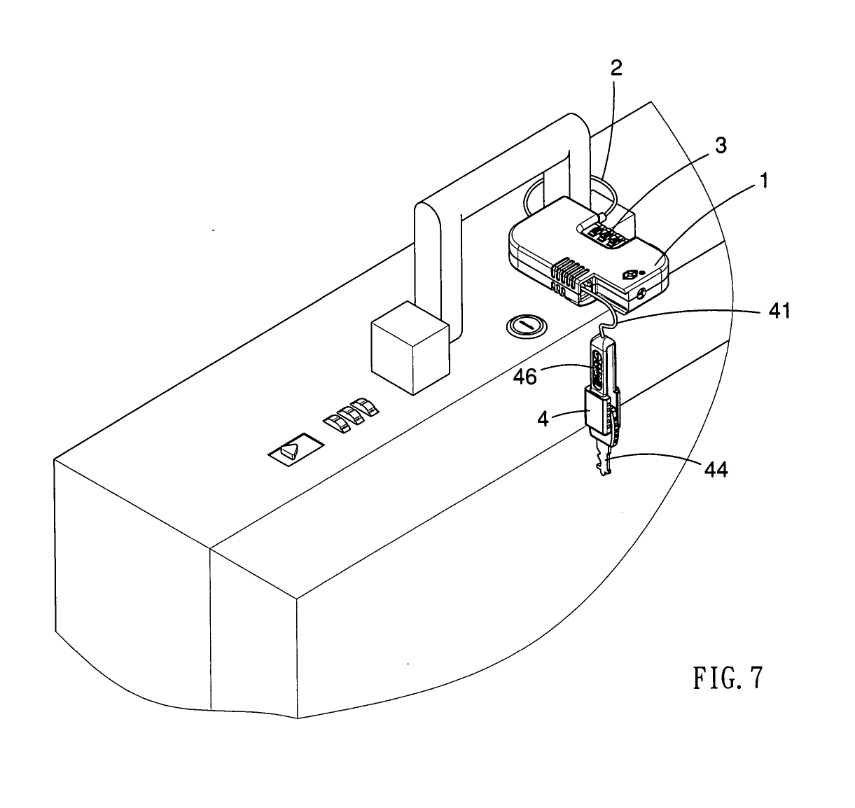

Furthermore, the indicator 46 is connected to or formed on the seal member 4 corresponding to the groove 18, shown in FIGS. 2 and 7, and the indicator 46 includes plural indicating members, such as self-adhesive indicating members or tags. The indicator 46 is provided for unlocking a combination lock of the suitcase and served as unlocking codes which specify and indicate the unlocking codes for the combination lock of the suitcase. Accordingly, the suitcase inspector and the suitcase owner can easily see the unlocking codes once the seal member 4 is detached from the shell 1 to further unlock the combination lock of the suitcase, as shown in FIG. 7.

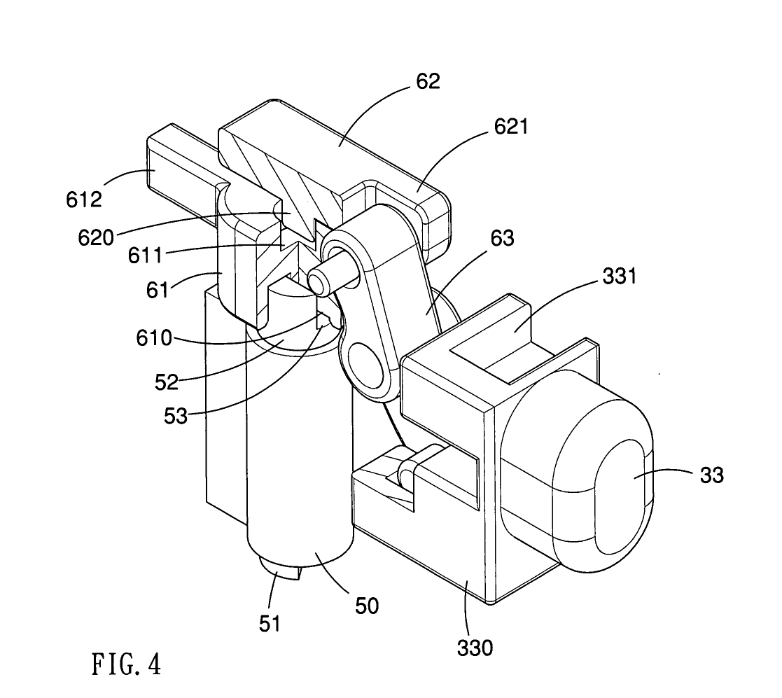

In FIGS. 2-4, 8 and 9, the key lock module 5 mainly comprises a lock core 50, a lock shaft 51, and a sleeve 61. The lock core 50 is fixed and installed in the third chamber 14 of the shell 1, and the lock shaft 51 is installed in the lock core 50 and rotatable via an exclusive key kept by the suitcase inspector. The lock shaft 51 has a keyhole formed at a bottom thereof for inserting the exclusive key. Furthermore, a top 52 of the lock shaft 51 is formed with a slit 53, which is provided for connecting to the sleeve 61, which is formed as a shape of elongated circle. In FIG. 4, a structure of the key lock module 5, the button 33, the linking unit 63, and the plate 62 is shown. The sleeve 61 of the key lock module 5 is connected to the top 52 of the lock shaft 51; and has a bar 612, an opening 611 and a rail 610. The bar 612 of the sleeve 61 is formed on a side of the sleeve 61 and engageable to the notch 400 of the seal member. The opening 611 of the sleeve 61 is formed on a top of the sleeve 61 and provided for receiving the rod 620 of the plate 62. The rail 610 is formed within the sleeve 61 for sliding upon the slit 53 of the lock shaft 51. Accordingly, the plate 62 is movable to drive the sleeve 61 to slide via the linking unit 63 to move a certain distance.

Furthermore, the linking unit 63 is pivoted on the shell 1 by a supporting rod 64 as shown in FIGS. 5 and 6; therefore, the linking unit 63 is swayable. The linking unit 63 connects between the base 330 of the button 33 and the end 621 of the plate 62. Accordingly, when the combination lock 3 is unlocked and the button 33 is pushed, the linking unit 63 is driven to make the plate 62 moving. Therefore, the sleeve 61 is slid via the rail 610 that causes the bar 612 of the sleeve 61 disengaged from the notch 400 of the seal member 4. Additionally, the key lock module 5 is not interfered by operations of the combination lock module 3.

More specifically, as shown in FIG. 5, the unlocking device of the first embodiment is locked, namely the combination lock module 3 and the key lock module 5 are locked. Accordingly, the fastening end 21 of the fastening member 2 is locked by the fastener 30 of the combination lock module 3 and the seal member 4 is in the locking position relative to the shell 1 due to the notch 400 of the seal member 4 is engaged with the bar 612 of the sleeve 61.

In FIG. 6, the stem 310 is movable, when the combination lock module 3 is unlocked by dialing the unlocking numbers of the numeral wheels 311. Accordingly, the fastener 30 can be slid within the sliding space 16 of the shell 1 to enable the fastening hole 300 of the fastener 30 to release the fastening end 21 of the fastening member 2. Furthermore, a needle-like article can be applied to move the fastener 30 via a though hole 110 of the shell 1 formed corresponding to the fastener 30, for example. Additionally, after the combination lock module 3 is unlocked, the button 33 can be pressed accordingly. Therefore, the linking unit 63 is moved by the button 33 and moves the plate 62, which further moves the bar 612 of the sleeve 61 to disengage from the notch 400 of the seal member 4. Accordingly, the seal member 4 can be moved to the unlocking position and the unlocking unit, namely the key 44 or the indicator 46 can be used to unlock the suitcase. Because the body 40 of the seal member 4 is connected to the cable 41, the possibility of losing the seal member 4 is solved.

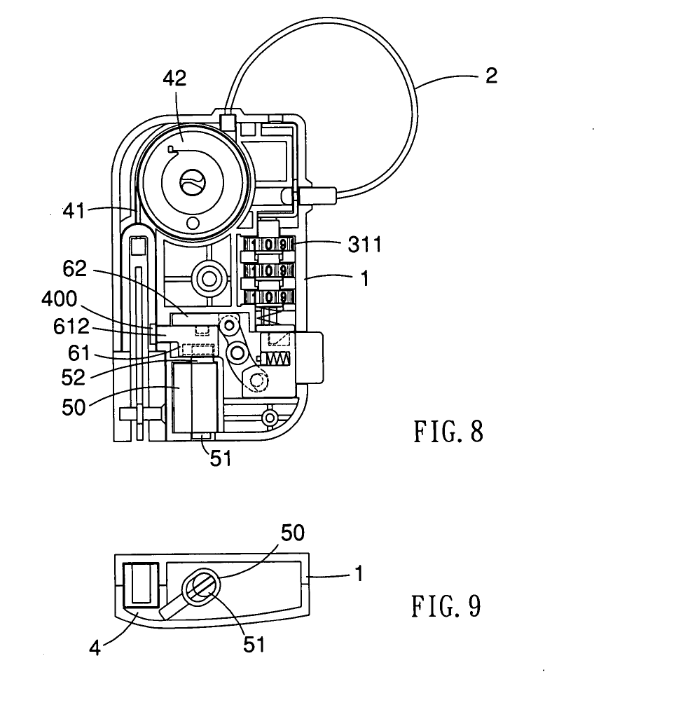

FIGS. 8-9 show that the key lock module 5 of the first embodiment is unlocked by the exclusive key kept by the suitcase inspector. The lock shaft 51 is rotated by the exclusive key and moves the sleeve 61 to rotate accordingly. Therefore, the bar 612 of the sleeve 61 is rotated away from and disengaged from the notch 400 of the seal member 4. Similarly to the above description, the seal member 4 can be moved to the unlocking position to further unlock the suitcase.

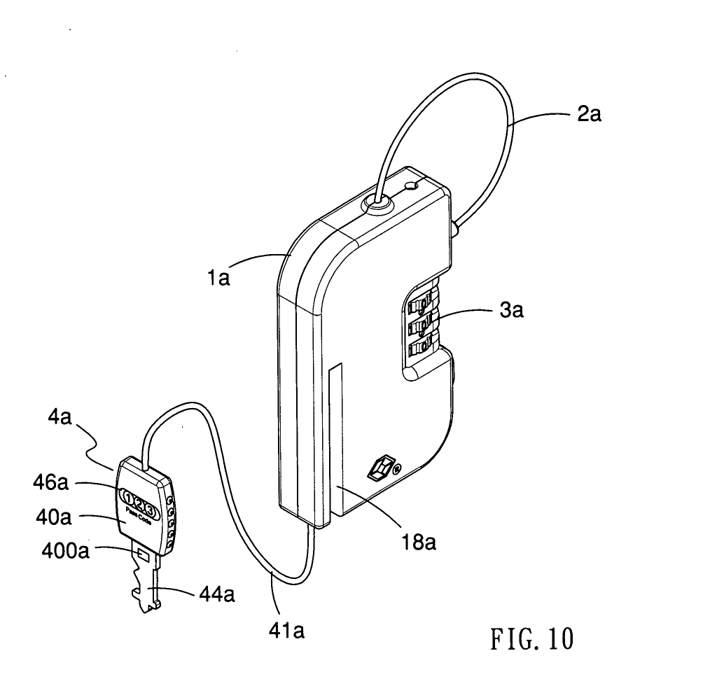

A second embodiment of the present invention is shown in FIG. 10. Similar to the first embodiment described above, an unlocking device of the second embodiment comprises a shell 1a, a combination lock module 3a, a seal member 4a, a key lock module (not shown), and an unlocking unit, which comprises a key 44a and an indicator 46a. The seal member 4a also has a cable 41a and a body 40a connected to the cable 41a. Different to the first embodiment, the key 44a is directly connected to an end of the body 40a and applies to be installed in a groove 18a of the shell 1a. Furthermore, a notch 400a can be formed on either the seal member 4a or the key 44a so as to be restricted by the combination lock module 3a and the key lock module.

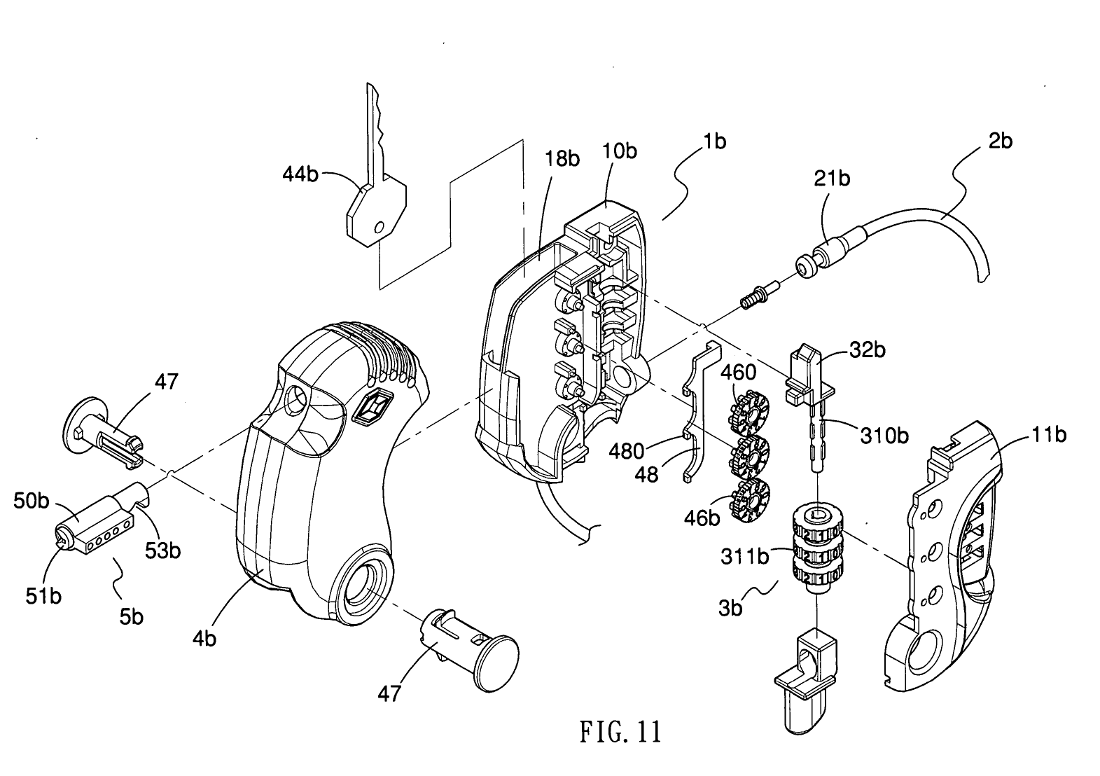

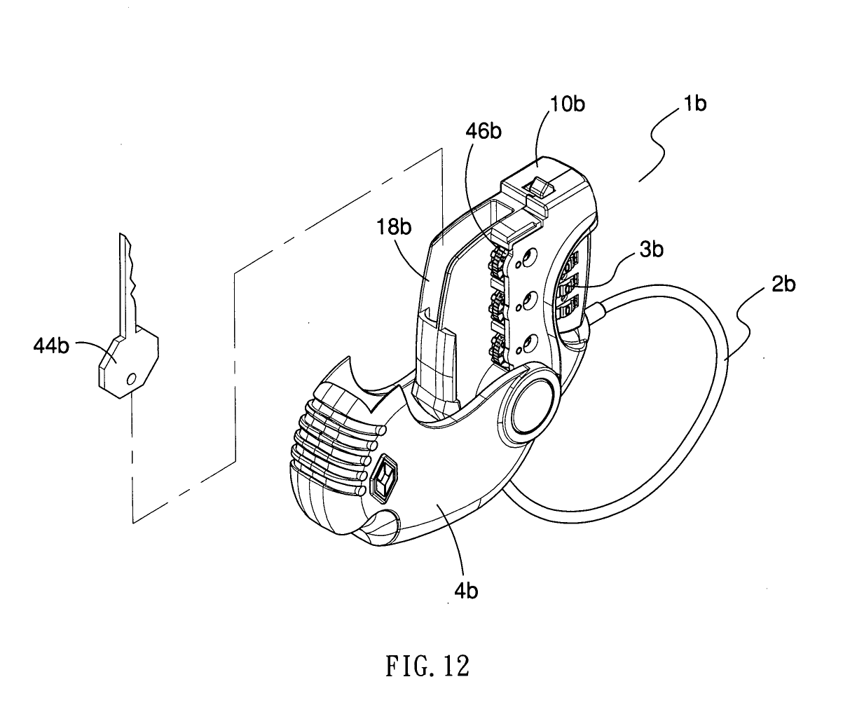

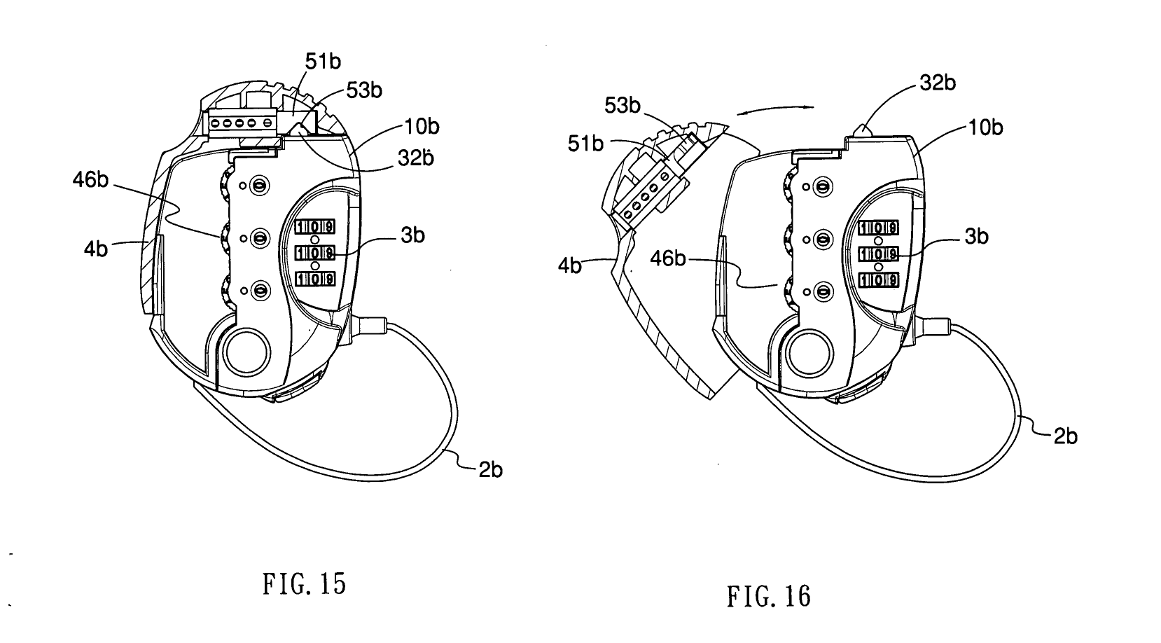

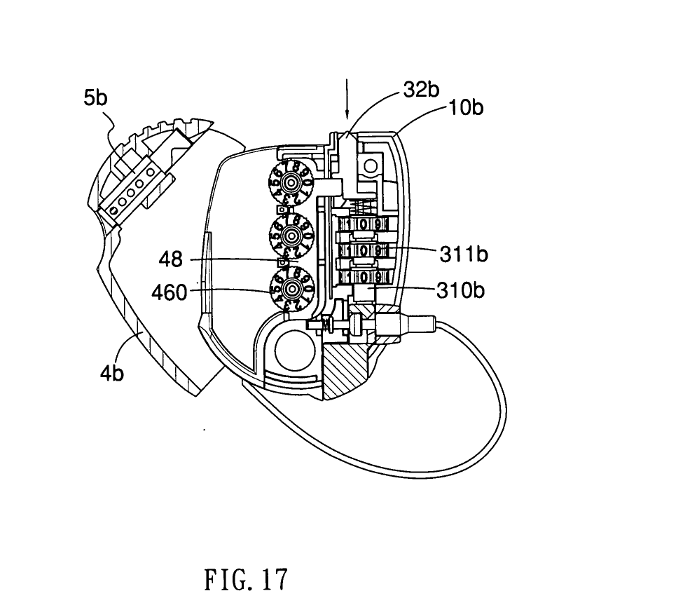

FIGS. 11-19 show another unlocking device as a third embodiment of the present invention. In FIG. 11, the unlocking device comprises a shell 1b, a fastening member 2b, a seal member 4b, a combination lock module 3b, a key lock module 5b and an unlocking unit, similar to the foregoing embodiments. The unlocking unit also comprises a key 44b and indicator 46b. Different to the first embodiment, the key lock module 5b of the third embodiment is installed in the seal member 4b; and the unlocking unit is received in the shell 1 and provided for unlocking the suitcase after the seal member 4b is moved to the unlocking position. Additionally, the seal member 4b is connected to the shell 1b by a pivot 47, whereby the seal member 4b is swayable relative to the shell 1b. The key lock module 5b of the third embodiment mainly comprises a lock core 50b and a lock shaft 51b. The lock core 50b is fixed in the seal member 4b. The lock shaft 51b is installed in the lock core 50b and rotatable via the exclusive key and has a gap 53b on a top of the lock shaft 51b. Furthermore, the combination lock module 3b comprises a stem 310b, plural numeral wheels 311b, a block 32b and a button 33b. The stem 310b is movably installed in the shell 1b. The numeral wheels 311b are installed on the stem 310b and provided for driving the stem 310b to move after unlocking numbers of the numeral wheels 311b are dialed. Additionally, the block 32b is elastically mounted on the stem 310b, and has an end engageable to the gap 53b of the lock shaft 51b. The block 32b is movable only after the unlocking numbers of the numeral wheels 311b are dialed.

The unlocking unit of the third embodiment further comprises a restricting plate 48, and the indicator 46b comprises plural indicating members 460 for indicating unlocking codes for a combination lock of the suitcase. The restricting plate 48 is connected between the combination lock module 3b and the indicating members 460 and provided for restricting the indicating members 460, which are movable via the restricting plate 48 after the combination lock module 3b is unlocked.

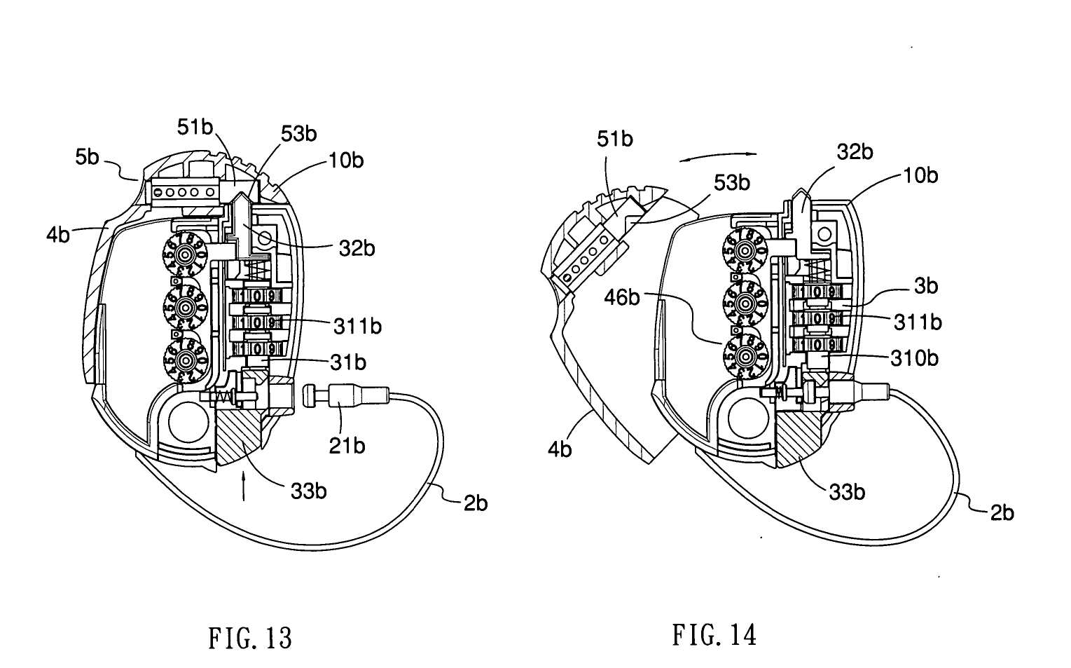

More specifically, in the third embodiment of the present invention, the key 44b is received in a groove 18b of the shell 1b, which consists of a front shell 10b and a back shell 11b. The seal member 4b is pivoted on the shell 1b by the pivot 47, which can be replaced by any conventional pivot technology, such as two suited rivets. Therefore, when the seal member 4b is moved to the locking position and connected to the shell 1b, the gap 53b of the lock shaft 51b is engaged with the block 32b. Additionally, the gap 53b of the lock shaft 51b and the block 32b are arranged to be disengaged from each other only after either one of the combination lock module 3b and the key lock module 5b is unlocked. As shown in FIGS. 13-17, the button 33b is connected to the stem 310b. When the combination lock module 3b is unlocked by dialing the unlocking numbers of the numeral wheels 311b, the button 33b can release a fastening end 21b of the fastening member 2b. Accordingly, the block 32b is movable downwardly to disengage from the gap 53b of the lock shaft 51b. When the lock module 5b is unlocked by the exclusive key, the lock shaft 51b can be rotated accordingly to disengage from the block 32b.

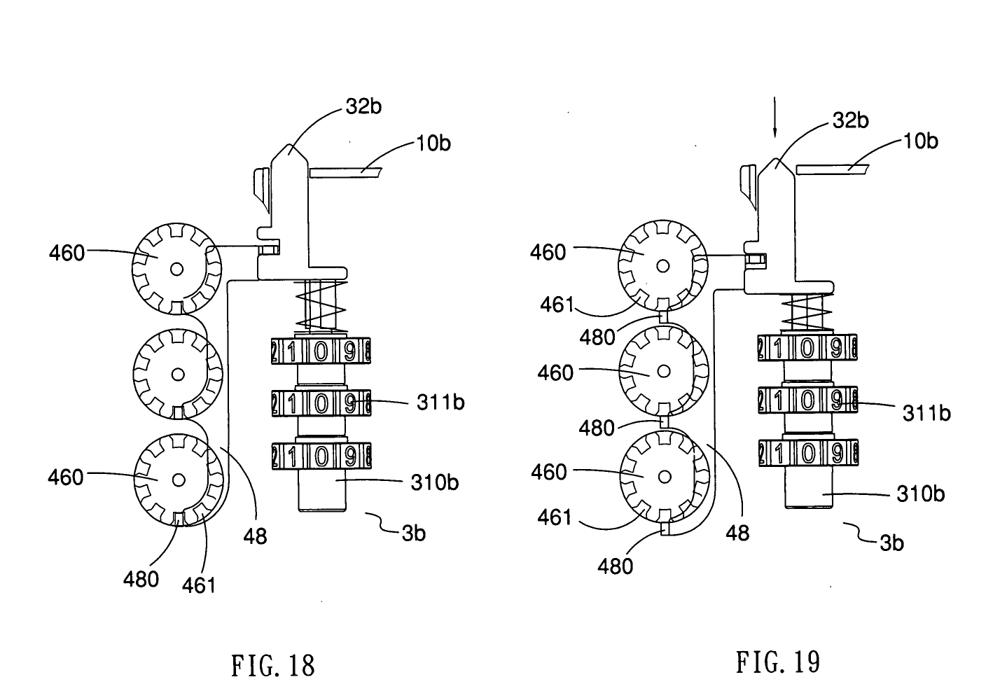

FIGS. 18-19 show connections between the indicator 46b, the combination lock module 3a and the restricting plate 48. The indicating members 460 of the indicator 46b are adjustable in order to change the unlocking codes previously indicated if necessary. Each one of the indicating members 460 has connecting teeth 461 thereon. The restricting plate 48 has an end connected to the block 32b, and the other end formed with engaging hooks 480, which are provided for respectively engaging with one of the respective connecting teeth 461. When the combination lock module 3b is unlocked, the block 32b is movable downwardly to drive the restricting plate 48 to move. Accordingly, the engaging hooks 480 are disengaged from the connecting teeth 461 so that the indicating members 460 can be adjusted.

In the third embodiment, the unlocking device has features of different connections between the shell 1b and the seal member 4b; and different structures of the indicator 46b, compared with the foregoing embodiments.

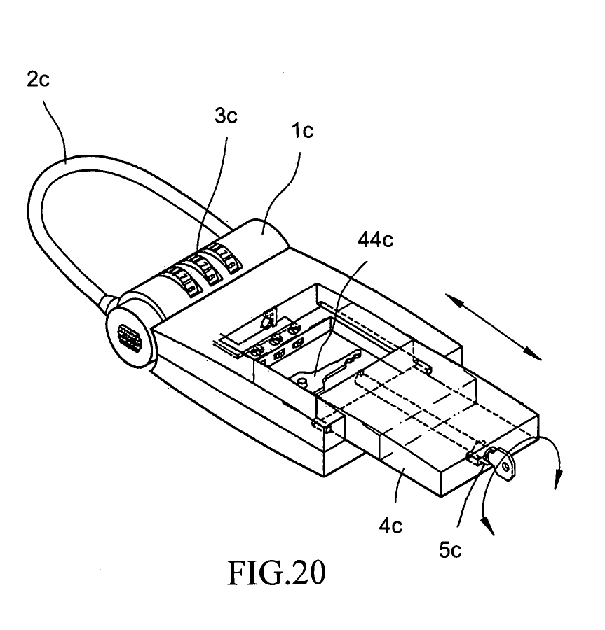

FIG. 20 shows a further unlocking device as a fourth embodiment of the present invention. Similar to the foregoing embodiments, the unlocking device comprises a shell 1c, a fastening member 2c, a combination lock module 3c, a seal member 4c, a key lock module 5c and an unlocking unit, which comprises a key 44c. The shell 1c has a groove for receiving the key 44c and the fastening member 2c is connected to the shell 1c. The combination lock module 3c is installed in the shell 1c and the key lock module 5c is installed in the seal member 4c. Additionally, the seal member 4c is connected to the shell 1c slidably and movable between a locking position to cover the key 44c and an unlocking position to uncover the key 44c. Furthermore, the seal member 4c is movable only after the combination lock module 3c or the key lock module 5c is unlocked; and the fastening member 2c can be disengaged from the shell 1c after the combination lock module 3c is unlocked.

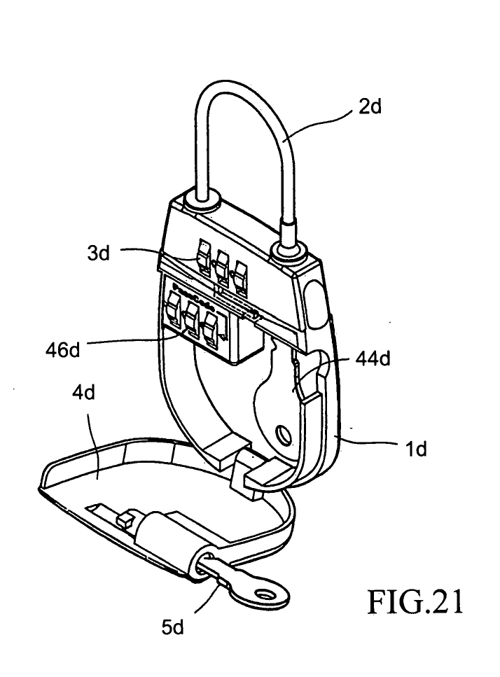

FIG. 21 shows a further unlocking device as a fifth embodiment of the present invention. Similar to the foregoing embodiments, the unlocking device comprises a shell 1d, a fastening member 2d, a combination lock module 3d, a seal member 4c, a key lock module 5c and an unlocking unit, which comprises a key 44d and an indicator 46d. The shell 1d has a groove for receiving the key 44d and the indicator 46d; and the fastening member 2d is connected to the shell 1d. The combination lock module 3d is installed in the shell 1d and the key lock module 5d is installed in the seal member 4d. Additionally, the seal member 4d is connected to the shell 1d pivotally and is movable only after the combination lock module 3d or the key lock module 5d is unlocked. The fastening member 2d can be disengaged from the shell 1d after the combination lock module 3d is unlocked.

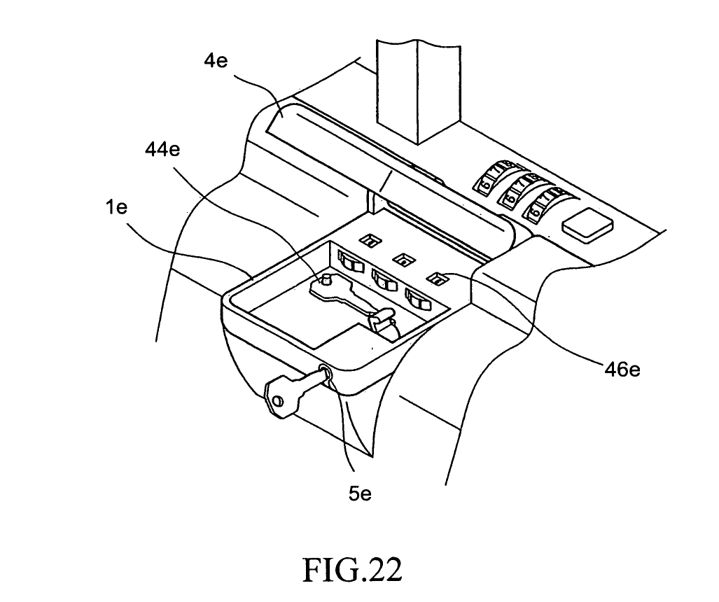

The above mentioned embodiments of the present invention show that the shell of the unlocking device is arranged to be hanged on the suitcase by applying the fastening member. Alternatively, the shell of the unlocking device can be also arranged to be unitedly connected to the suitcase as shown in FIGS. 22-24.

FIG. 22 shows a further unlocking device as a sixth embodiment of the present invention. Similar to the foregoing embodiments, the unlocking device comprises a shell 1e, a seal member 4e, a key lock module 5e and an unlocking unit, which comprises a key 44e and an indicator 46e. The shell 1e is unitedly connected to the suitcase and has a groove for receiving the key 44e and the indicator 46e. The key lock module 5e is installed in the shell 1e. Additionally, the seal member 4e is connected to the shell 1e pivotally and is movable only after a combination lock module of the suitcase or the key lock module 5e is unlocked.

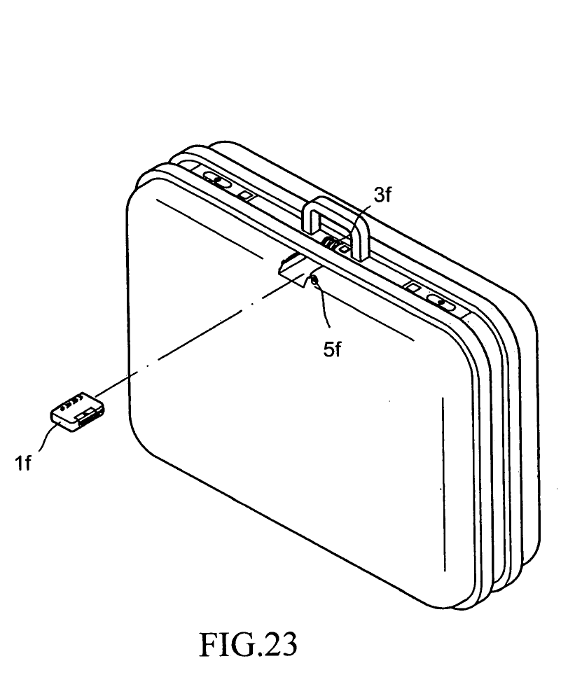

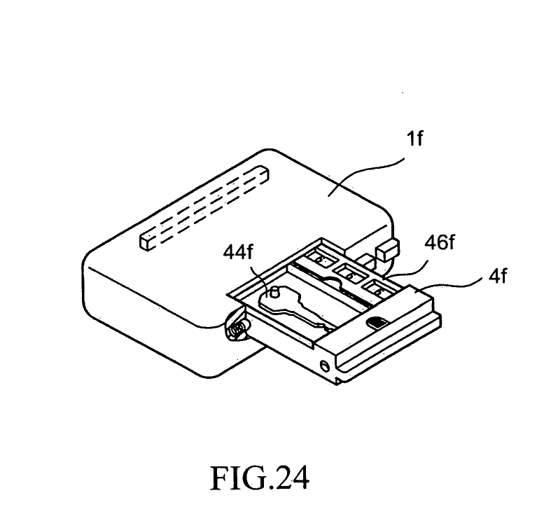

FIGS. 23 and 24 show a further unlocking device as a seventh embodiment of the present invention. Similar to the foregoing embodiments, the unlocking device comprises a shell 1f, a seal member 4f, and an unlocking unit, which comprises a key 44f and an indicator 46f. The shell 1f is insertedly connected to the suitcase and has a groove for installing the seal member 4f, which is provided for installing the key 44f and the indicator 46f. The seal member 4f is slidably connected to the shell 1f. Furthermore, a key lock module 5f and a combination lock module 3f can be further alternatively installed in the suitcase. Therefore, the shell 1f is movable and the seal member 4f can be moved to an unlocking position only after the combination lock module 3f or the key lock module 5f is unlocked.

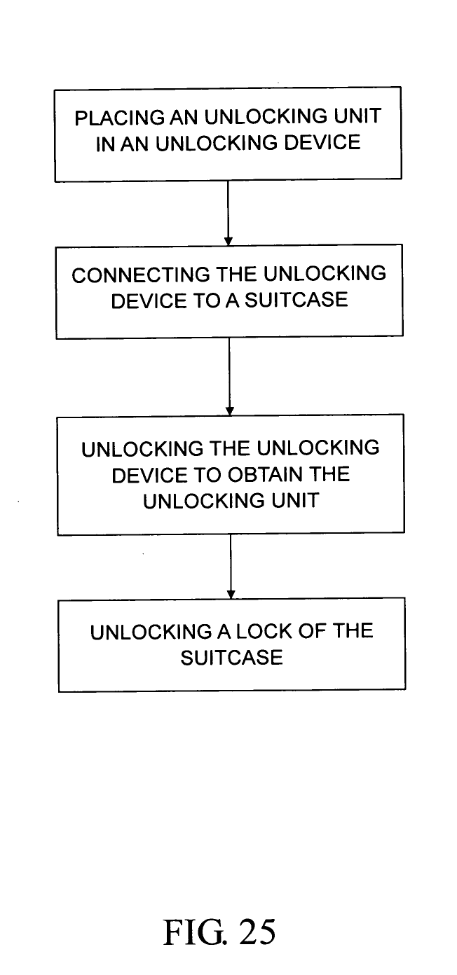

FIG. 25 further shows a method for unlocking a suitcase, which has at least one lock provided for locking the suitcase; and the method comprises the steps of: connecting an unlocking device to the suitcase, unlocking the unlocking device to obtain an unlocking unit; and unlocking the at least one lock of the suitcase by the unlocking unit. Additionally, the unlocking device comprises an unlocking unit pre-placed therein as described in the above descriptions and can be opened by either using an exclusive key kept by an inspector or dialing unlocking codes memorized by the owner of the suitcase. Thus, the suitcase inspector can use the exclusive key to open the unlocking device, to obtain the unlocking unit and to unlock the suitcase by using the unlocking unit when an inspection to the suitcase is required.

Numerous characteristics and advantages of the invention have been set forth in the foregoing description, together with details of the structure and function of the invention, and the novel features thereof are pointed out in appended claims. The disclosure, however, is illustrative only, and changes may be made in detail, especially, in matters of shape, size and arrangement of parts, materials and the combination thereof within the principle of the invention, to the full extent indicated by the broad general meaning of the terms in which the appended claims are expressed.

We claim:

1. An unlocking device that can be connected to a suitcase for security inspections, comprising:
a shell;
a seal member, connected to the shell and movable between an unlocking position and a locking position relative to the shell;
a combination lock module, installed in the shell and provided for allowing the seal member to move from the locking position to the unlocking position after the combination lock module is unlocked;
a key lock module, installed in the shell and provided for allowing the seal member to move from the locking position to the unlocking position after the key lock module is unlocked; and
an unlocking unit, connected to the seal member and provided for unlocking the suitcase after the seal member is moved to the unlocking position.

2. The unlocking device of claim 1, wherein the seal member comprises:
a spool, provided for installing in the shell;
a cable, having one end for winding around the spool, wherein the cable is arranged to be retractable back to the spool; and
a body, connected to the other end of the cable.

3. The unlocking device of claim 1, wherein the shell has a groove provided for installing the seal member.

4. The unlocking device of claim 1, wherein the unlocking unit comprises a key connected to the seal member provided for unlocking a key lock of the suitcase.

5. The unlocking device of claim 1, wherein the unlocking unit comprises an indicator connected to the seal member provided for unlocking a combination lock of the suitcase.

6. The unlocking device of claim 1, wherein the shell is arranged to be hanged on the suitcase.

7. The unlocking device of claim 1, wherein the shell is arranged to be unitedly connected to the suitcase.

8. The unlocking device of claim 1, wherein:
the seal member has a notch formed thereon;
the key lock module, comprises:
a lock core, fixed in the shell;
a lock shaft, installed in the lock core and rotatable via an exclusive key; and
a sleeve, connected to a top of the lock shaft and rotatable by the lock shaft, wherein the sleeve has a bar formed on a side of the sleeve and engageable to the notch of the seal member; an opening formed on a top of the sleeve; and a rail formed within the sleeve for sliding upon the lock shaft; and
the combination lock module, comprises:
a stem, movably installed in the shell;
plural numeral wheels, installed on the stem and provided for driving the stem to move after unlocking numbers of the numeral wheels are dialed;
a block, elastically mounted on a bottom of the stem;
a button, movably connected to the block, wherein the button has a recess provided for receiving the block, and the button is movable only after the unlocking numbers of the numeral wheels are dialed;
a linking unit, swingably connected to the button; and
a plate, having a rod installed in the opening of the sleeve; and
an end connected to the linking unit, wherein the plate is movable to drive the sleeve to slide via the linking unit.

9. The unlocking device of claim 2, wherein the body of the seal member has a slot; and the unlocking unit comprises a key pivotally received in the slot of the body for unlocking a key lock of the suitcase.

10. The unlocking device of claim 4, wherein the unlocking unit further comprises an indicator connected to the seal member for unlocking a combination lock of the suitcase.

11. The unlocking device of claim 6, further comprising a fastening member provided for hanging the shell on the suitcase, wherein the fastening member having a connecting end connected to a first side of the shell; and a fastening end connected to the combination lock module through a second side of the shell, and wherein the fastening end can be removed from the combination lock module only after the combination lock module is unlocked.

12. An unlocking device that can be connected to a suitcase for security inspections, comprising:
a shell;
a seal member, connected to the shell and movable between an unlocking position and a locking position relative to the shell;
a combination lock module, installed in the shell and provided for allowing the seal member to move from the locking position to the unlocking position after the combination lock module is unlocked;
a key lock module, installed in the seal member and provided for allowing the seal member to move from the locking position to the unlocking position after the key lock module is unlocked; and
an unlocking unit, received in the shell and provided for unlocking the suitcase after the seal member is moved to the unlocking position.

13. The unlocking device of claim 12, wherein the unlocking unit comprises a key installed in the shell and provided for unlocking a key lock of the suitcase.

14. The unlocking device of claim 12, wherein the unlocking unit comprises an indicator installed in the shell and provided for unlocking a combination lock of the suitcase.

15. The unlocking device of claim 12, wherein the shell is arranged to be hanged on the suitcase.

16. The unlocking device of claim 12, wherein the shell is arranged to be unitedly connected to the suitcase.

17. The unlocking device of claim 12, wherein the seal member is connected to the shell by a pivot, whereby the seal member is swayable relative to the shell.

18. The unlocking device of claim 12, wherein:
the key lock module, comprises:
a lock core, fixed in the seal member; and
a lock shaft, installed in the lock core and rotatable via an exclusive key, wherein the lock shaft has a gap thereon; and
the combination lock module, comprises:
a stem, movably installed in the shell;
plural numeral wheels, installed on the stem and provided for driving the stem to move after unlocking numbers of the numeral wheels are dialed; and
a block, elastically mounted on the stem, wherein the block has an end engageable to the gap of the lock shaft and the block is movable only after the unlocking numbers of the numeral wheels are dialed.

19. The unlocking device of claim 13, wherein the unlocking unit further comprises an indicator installed in the shell and provided for unlocking a combination lock of the suitcase, wherein the indicator comprises plural indicating members for indicating unlocking codes for the combination lock of the suitcase; and a restricting plate connected between the combination lock module and the indicating members for restricting the indicating members, and wherein the indicating members are movable via the restricting plate after the combination lock module is unlocked.

20. A method for unlocking a suitcase, which has at least one lock provided for locking the suitcase, and the method comprising the steps of:
connecting an unlocking device to the suitcase, wherein the unlocking device comprises an unlocking unit pre-placed therein and can be opened by either using an exclusive key kept by an inspector or dialing unlocking codes memorized by the owner of the suitcase;
unlocking the unlocking device to obtain the unlocking unit; and
unlocking the at least one lock of the suitcase by the unlocking unit.
